(19) United States
(12) Patent Application Publication
(10) Pub. No.: US 2004/0005252 A1
(43) Pub. Date: Jan. 8, 2004

(54) Preventing the transmission of disease

(76) Inventor: Harold Edward Siess, Montgomery Village, MD (US)

Correspondence Address: Harold E. Siess, 8629 Welbeck Way, Montgomery Village, MD, 20886, US

(21) Appl. No.: 10/613,093

(22) Filed: Jul. 7, 2003

Related U.S. Application Data
(63) Continuation-in-part of application No. 09/908,748, filed on Jul. 20, 2001, now abandoned.

(51) Int. Cl. B01J 19/08

(52) U.S. Cl. 422/186.3

(57) ABSTRACT

The present invention provides for apparatus for the conditioning of air for human use. The apparatus is comprised of: (a) a fluid flux generator for generating a flux of particulate precursor material; an activator for activating said particulate precursor material in a gas-to-particle reaction for forming atmospherically unstable products for the encapsulation of harmful airborne agents.

### BACKGROUND OF THE INVENTION

The removal of pathogens from indoor air is hindered by their extremely small size, ability to propagate and to resist chemical agents nontoxic to humans. Air purifiers utilizing germicidal UV radiation lamps require an excessive number thereof to attain a desired level of efficiency and consequently are expensive to manufacture and maintain.

The viability of the SARS virus has recently been shown to be a function of the pH of its surrounding fluid. In particular, it has been shown that the more acidic the fluid the lower the viability of the SARS virus is over time.

### OBJECTS OF THE INVENTION

The object of the present invention is to provide for a method and apparatus for securing the comfort and health of human beings by the production and maintenance of conditioned air for which they are to be surrounded.

A further object of the present invention is the provision of a method and apparatus for treating air for the purposes of improving its general suitability for breathing, such as by the removal of organic compounds, oxidative radicals, odors, dust, pollen, bacteria, viruses and the like and/or to deactivate the biological activity thereof for lowering the contact potential of the harmful airborne agents which may not actually be removed from the air.

It is a still further object of the present invention to provide for a method and apparatus for the prevention of disease by the acidification of the air and surfaces that come into contact with such air for lowering the viability of the SARS virus. In particular, it is an object of the present invention to provide for the acidification of the respiratory tract of one or more individuals for (1) providing an acidic shield against the SARS virus those individuals not having the disease; (2) for reducing the viability of the SARS virus in fluids commuted to the environment by infected individuals by the acidification of the same.

It is yet still another object of the present invention to provide for method and apparatus for providing a reductive shield in the respiratory tract of an individuals for the protecting the individual from oxidative radicals.

To the foregoing and other useful ends, the present invention also inherently comprises such other objects, advantages, and capabilities as will more fully appear hereinafter.

### SUMMARY OF THE INVENTION

It is to be understood that the phraseology or terminology employed herein is for the purpose of description and not of limitation, and it is not intended to limit the invention claimed herein beyond the requirements of the prior art.

Webster's New Universal Unabridged Dictionary defines an atmophile as

1. Having an Affinity for the Atmosphere, as Neon or Helium.

As used herein the term “atmophobic particle” is defined as a particle having an aversion for the atmosphere which can be, for example, in the form of a semi-volatile or in-volatile compound or cluster, aggregate, complex or agglomeration containing same said compounds.

As used herein the term “semi-volatile compounds” is defined as those compounds having either saturation vapor pressures below 30 mm Hg and/or have boiling points above 260° C.

As used herein the term “atmospherically unstable products” is defined as products produced by a gas-to-particle reaction that are capable of being nucleated or condensed out of air between the temperatures of between 0° C. and 100° C.

As used herein the term “atmospherically supersaturated products” is defined as gaseous reaction products in a state of supersaturation.

The term “agglomerable” and its variant forms herein refers to any material capable of agglomerating, flocculating, or clustering, coalescing or fusing with other particles or portions of the same material when processed in accordance with the teaching of the present invention.

As used herein the term “ozonide” means any of the peroxides produced by ozonolysis reaction, such as but not limited to, α-ozonide, β-ozonide, hydroxyperoxide, diperoxide and the like.

As used herein the words “contact potential” is defined as the ability of an airborne particle to contact and harm an individual by such contact such as by infection thereby or by an immunogenic or otherwise irritative or lethal response thereto.

As used herein a halogenoid means a molecule comprising a halogen. As used herein a halogenic oxidation reaction means a reaction wherein a halogen or halogenoid is reacted for adding or adding additional oxygen atoms thereto.

As used herein the term “terpene” and all of its derivatives means hydrocarbons formed by the polymerization of 5-carbon isoprene subunits which can be in the form of chains or rings and their reduced and oxidized forms including but not limited to alcohols, ketones, acids, and aldehydes.

As used herein the term “co-activator” means an activator that activates a species produced by a different type of activator.

As used herein the term “replicating bio-particle” means a particle capable of providing sequenced molecular information in a natural replication process including particles such as bacteria, mold, fungi, viruses, and pollen.

It is the primary purpose of the present invention to control the undesirable effects of gas-borne or otherwise suspended organic matter as found in breathable air, such as but not limited to, bio-aerosol particles and hydrocarbons without the need for the collection of the same. In particular, the primary purpose of the present invention it to control the contact potential of harmful airborne agents suspended in air. More particularly, it is the primary purpose of the present invention to control the undesirable effects of suspended organic matter without the need of expertise maintenance or the production of toxic or otherwise harmful wastes by use of a self contained and self regulated air handling device that allows for the continuous treatment of air over an extended period of time without interruption such as might curtail any operation which may be dependent upon the continuity thereof.

As an aid to understanding the present invention it can be stated in summary form that it concerns what is broadly considered as an air purification process through means for forming particulates by reactive methods. When employed in the intended manner, the formation of particulates as described in the present invention serves to at least partially coat or encapsulate the organic matter for either (1) forming gaseous matter that is less harmful, irritative or toxic to humans, and/or (2) can be more easily removed from the gaseous phase by mechanical, electrostatic, inertial or incinerating methods.

The formation of particulates in accordance with the teachings of the present invention also provides for a convenient bases for the simultaneous remediation and detection of the organic matter, by for example, cluster techniques as described in my U.S. application entitled Method and Apparatus for the Detection and Characterization of Particles or by the methods and apparatus incorporated herein.

In consideration of the present invention, it may be understood that though the air conditioner is designed primarily for the purpose of deactivating the biological activity of bacteria, viruses and pollen that may be present in the air, the conditioner is also capable of use for various other purposes, such as for instance, maintaining low particle counts in food storage or food handling enclosures, pharmaceutical plants, semiconductor plants and in other various fields of endeavor wherein cleanliness and purity of air are considered necessary or desirable.

In the first step of the method for the conditioning of air for human use, a complete set of reactants is furnished for undertaking a gaseous phase chemical reaction of the general type

A+B [symbol] products (1A)

for forming atmospherically unstable products or atmophobic products or intermediaries that subsequently react to form such products without the need for one or more of the contaminants contained in the air to act as constituents thereof. In one form of the invention, reaction 1A is a reactant driven reaction wherein the complete set of reactants is in the form of extraneous materials that are not obtained or produced from a portion of the air to be processed. In another form of the invention, reaction 1A is an air driven reaction wherein one or more of the reactants are derived from air.

Reaction 1 may be carried out by the simple mixing of the constituents thereof or an initiator and/or activator may be used to promote, activate or otherwise bring about reaction 1. The initiators and/or activator can be, but are not limited to, (1) actinic radiation from natural or manmade sources such as microwaves, infrared radiation, solar rays, UV radiation, gamma rays, and x-rays and/or (2) energetic charged particles such as electrons or ions and/or (3) chemical species such as free radicals, photochemical sensitizers, oxygen allotropes, auto-oxidative or autocatalytic species such as peroxides and the like.

The atmospherically unstable products can be in the form of molecules, dimers, polymers and/or clusters. The clusters can be in the form of liquids, solids, semi-solids or mixtures thereof. In the preferred form of the invention, the products are nontoxic, nonirritating, non-odorous, nonexplosive compounds in the concentrations produced and as such can be inhaled for prolonged periods of time. It is also preferred that reaction 1 be carried out for forming products that do not leave objectionable films, coatings or stains on walls and furniture, do not damage electronic equipment and have a tendency to degrade over time and as such may be disposed of to the atmosphere or to sewers directly.

In the second step of the remediation process, the atmospherically unstable products come out of the gas phase for coating or bathing the contaminants with an outer coating for forming a plurality of synthetically produced aerosol or aeriform particulates. In one form of the invention, the atmospherically unstable products are produced and nucleated within the air to be treated. In this form of the invention the harmful airborne agents actively participate in the nucleation process by for example, and in no way limiting the present invention to any particular mode of particulation, (1) acting as nucleation embryos for the atmospherically unstable products; and/or (2) heterogeneously condensing with the atmospherically unstable products; and/or (3) otherwise being caught up in the nucleation process.

In another form of the invention, the atmospherically unstable products are produced outside of the air to be treated and then mixed therewith for forming at least partially coated or encapsulated harmful airborne agents. In this form of the invention, the thus formed atmospherically unstable products can be either (1) mixed with the air before complete particulation occurs for nucleating in the presence of the harmful airborne agents or (2) the atmospherically unstable products can be allowed to at least partially particulate before being mixed with the air for uniting the thus formed particulates with the harmful airborne agents by either adsorption or absorption processes.

In the preferred form of the invention, the atmospherically unstable products are nucleated by heterogeneous nucleation for (1) increasing the rate of the particulation process and/or for (2) increasing the relative size of the thus formed particulates and/or (3) for otherwise lowering the saturation vapor pressure of at least one of the atmospherically unstable products. In one form of the invention, a heterogeneous nucleating mixture is formed for this purpose by selecting reactants for participating in reaction 1 for forming a plurality of differing types of particulating products. This can be achieved by either (1) selecting two or more reactants that yield a plurality of differing types of particulating products in a reaction of the type

A+B [symbol] C+D+E etc, (1B)

and/or a set of particulating reactions of the type described in equation 1 may be simultaneously carried out for forming a plurality of differing types of particulating products.

In another form of the invention for increasing the heterogeneousness of the nucleation process, one or more coactive agents are mixed with the atmospherically unstable products for heterogeneously nucleating therewith. The co-active agents can be in the form of a co-condensating agent wherein the increase in the nucleated product is more or less proportional to the amount of co-condensating agents employed. In the preferred form of the invention, the co-active agents are in the form of colligative agents whereby a greater degree of nucleated product is obtained. In this form of the invention, the colligative agents may be chosen for (1) having a high liquid or solid solubility with the atmospherically unstable products and/or (2) are capable of forming an azeotropic mixture therewith. For example, for atmospherically unstable products having either an ionic or polar nature a colligative agent in the form of a polar hydrocarbon and/or molecularly disperse water i.e., humidity may be mixed with the atmospherically unstable products for forming a heterogeneously nucleating mixture therewith.

In one form of the invention, the co-active agents may be added to the mixture of reactants prior to reaction for the subsequent involvement in the particulation process. In this form of the invention, the co-active agents can be in the form of compounds that do not react during the union of the reactants.

In another form of the invention, the co-active agents may be added to the atmospherically unstable products after their formation for either (1) maintaining the chemical integrity of the agents and/or (2) for accelerating the particulation process outside of the reaction region.

The harmful airborne agents can be treated by either the use of a single particulation reaction occurring in a single particulation reaction chamber or the harmful airborne agents may be treated by the use of a sequence of particulating reactions occurring in a plurality of spatially separated chambers. In one form of the invention using a sequence of particulating reactions, one or more particular types or classes of harmful airborne agents are both particulated and removed from the air in a first particulation reaction and the other remaining harmful airborne agents are then remediated in a second particulation reaction.

In another form of the invention for treating the harmful airborne agents in a sequence of particulation reactions, one or more types of harmful airborne agents are repeatedly particulated in a sequence of differing particulation reactions and/or non-reactive particulation processes for either (1) increasing the probability of removal from the air by the modification of either the size or surface properties of the particulates and/or (2) for decreasing the contact potential of the harmful airborne agents by encasing them in several layers of differing atmospherically unstable products.

A convenient class of particulation reactions for the conditioning of breathable air by use of either a single or a sequence of particulation reactions are oxygen addition reactions such as but not limited to, an oxidation and/or hydrolysis reaction wherein oxygen or one or more of its conjunctive forms is added to one or more of the reactants for forming atmospherically unstable products.

As an illustrative non-limiting example, oxidation reaction 1 can be in the form of a combustion type oxidation reaction involving a particulate precursor hydrocarbon and oxidant of the general form

hydrocarbon+oxygen containing oxidant [symbol] particulates (2A)

wherein a hydrocarbon is oxidized for forming atmospherically unstable products in the form of incompletely oxidized hydrocarbons, such as for example, a hydrocarbon having additional numbers of oxygen atoms attached thereto. In the preferred form of the invention, the hydrocarbon is chosen for having a high aerosol formation potential in that the major fraction of products can be converted to the particulate phase.

As an illustrative example of a combustion type of oxidation reaction, reaction 2A can be in the form of an ozonolysis reaction of the general type

Hydrocarbon+ozone [symbol] particulating products. (2B)

The ozone may be produced by any known art method and apparatus and then mixed with the hydrocarbon for subsequent reaction therewith or the ozone may be produced within a mixture of air and hydrocarbon gas by air activation processes, such as but not limited to, (1) irradiating the air/hydrocarbon mixture with UV light having a wavelength sufficiently short for photochemically producing ozone [around 180 nm] and/or by discharge processes occurring within the air/hydrocarbon mixture.

Suitable hydrocarbons for reacting with ozone for producing oxygenated particulating compounds include, but are not limited to, hydrocarbons having a multiple bond such as alkynes, alkenes, cycloalkenes, dienes, and the like. In those cases wherein an initiator is used to initiate reaction 2A a hydrocarbon having at least one unsaturated excited state that is achievable by the absorption of energy may also be used for reacting with ozone.

In the preferred form of the invention, the hydrocarbon used in conjunction with ozone is an olefinically or aromatically unsaturated cyclic hydrocarbon having 6 or more carbon atoms for forming particulating oxygenated products in the form of oxygen containing organic compounds having one or more of the properties (1) a less unsaturated configuration, (2) a less ringed structure, (3) a higher molecular weight and/or (4) a lower vapor pressure then the initial hydrocarbon.

In those cases wherein a natural, outdoor, rich floral environment is to be enjoyed naturally occurring terpenic particulate precursor hydrocarbons as found in essential oils including but not limited to monocyclic, bicyclic or acyclic terpenes, sesquiterpenes and terpenoid compounds such as but not limited to pinene, ocimene, sabinene, triclene nerol, citral, camphor, menthol, and limonene and sesquiterpenes such as but not limited to nerolidol, cadinene, humulene, caryophyllene and farnesol may be used. In the preferred form of the invention, the terpenic compound is in the form of an oxygen containing terpene or terpenoid such as but not limited to the alcohols, aldehydes and ketones thereof.

The use of unsaturated compounds such as the terpenes in the ozonolysis reaction allows for production of particulating products in one or more of the following forms; ozonides, peroxides, molozonide, single and multifunctional oxygenated compounds such as carboxylic acids, dicarboxylic acids, percarboxylic acids, peroxycarboxylic acids, organic peracids, aldehydes and polyols. The use of unsaturated compounds also allows for the production of particulating products having multifunctional groups, such as but not limited to, polar and nonpolar groups, for particulating onto a plurality of different types of harmful airborne agents having differing hydrophobic tendencies.

Other olefinically or aromatically unsaturated cyclic compounds useful in accordance with the teachings of the present invention are the diene class of compounds including, but not limited to, styrene, indene, and cyclopentadiene. In this form of the invention the dienes or diene like reactants may be chosen for both oxidizing and polymerizing simultaneously during reaction 1A for forming a particulating primary oxidation product in the form of high molecular weight polymers having a gummy or resinous consistency.

Molecular disperse water (MDW), i.e., humidity, may be added to reaction 2A or removed therefrom for modifying the amount and/or kind of atmospherically unstable products such as, for example, the amount of acid or peroxide products in the ozonolysis reaction 2B.

Reaction 2B may be initiated and/or accelerated by the use of UV light having either (1) a wavelength of about 254 nm or thereabout for dissociating ozone into radicals or (2) for exciting the hydrocarbon by adsorption processes. Reaction 2B may also be initiated and/or accelerated by the use of a discharge source.

In the preferred form of the invention, the hydrocarbon reactant is used in excess for removing all of the ozone. In addition, an ozone decompositional olfactory prominent compound, such as but not limited to, thiophenes, mercaptans and nitrogen compounds such as primary, secondary and tertiary amines may be added to the reactant mixture of reaction 2B for giving a sensation indicating the lack of sufficient ozone or ozone production needed for reaction 2B. In the preferred form of the invention, the olfactory prominent compound has a higher ozone reactivity than the hydrocarbon reactant of reaction 2B.

Suitable co-active agents that may be added after reaction 2A or 2B in the range of 1 TO 10,000 parts per million include water and low molecular weight alcohols and glycols. Suitable examples of alcohols include but are not limited to monovalent alcohols such as methyl alcohol, ethyl alcohol, n-propyl alcohol, isopropyl alcohol, n-butyl alcohol, sec-butyl alcohol, tert-butyl alcohol, isobutyl alcohol, namyl alcohol, hexyl alcohol, heptyl alcohol, octyl alcohol, mixtures thereof and the like. Suitable examples of glycols include ethylene glycol, polyether polyols, diethylene glycol, triethylene glycol, 1,2-propylene glycol, dipropylene glycol, 1,3-butanediol, 1,4-butanediol, neopentyl glycol, trimethylol propane, 1,6-hexanediol, pentaerythritol, trimethylol propane, tetramethylolpropane, dipentaerythritol mixtures thereof and the like. Other co-condensating or colligative species that may be added to the particulating atmospherically unstable products after reaction include ketones, aldehydes, ethers, esters, hydrocarbons, glycol ethers and lactones. Suitable hydrocarbons include hexane, heptane, octane, decane, cyclopentane, cyclohexane mixtures thereof and the like. Suitable ether type co-condensating or colligative species include butyl ether, ethylene glycol-diethylether, ethylene glycolmonoethyl ether, ethylene glycol-monobutylether mixtures thereof and the like. Suitable ketones include acetone, methyl ethyl ketone, methyl propyl ketone, methyl isobutyl ketone, methyl amyl ketone, cyclohexanone mixtures thereof and the like. Suitable esters include ethyl formate, methyl acetate, propyl acetate, butyl acetate, phenyl acetate, ethylene glycolmonoethyl ether acetate, methylpropionate mixtures thereof and the like.

In addition, a scent compound, such as but not limited to, a terpenic compound may be supplied to the particulating products for assuring the complete removal of ozone and for giving the air a pleasant scent after treatment.

In another form of the invention, an acid such as acidic acid, nitric acid or sulfuric acid is used in conjunction with UV light for oxidizing organic compounds for forming particulating products. A suitable source of nitric acid or sulfuric acid is the vapor from a solution thereof.

In another form of the invention, reaction one is in the form of a combustion process wherein gaseous hydrogen peroxide is activated by UV light for oxidizing a particulate precursor such as, for example, a hydrocarbon in the reaction

H₂O₂+HYDROCARBON [symbol] UV [symbol] PARTICULATING PRODUCTS (3)

The use of UV activated hydrogen peroxide in the above reaction allows for a greater number of differing types of hydrocarbons to be removed from the air by oxidative processes involving a hydroxyl radical as compared to the simple use of ozone.

This form of the invention, is particularly useful for the remediation of harmful airborne agents in the form of organic compounds such as but not limited to benzene, xylene, toluene, methyl ethyl ketone, formaldehyde, trichloroethylene, and other chlorinated solvents.

A suitable reaction for the formation of atmospherically unstable products using halogens as reactants is given below as one of the many types of reactions that can be used in accordance with the teachings of the present invention.

HALOGENIC COMPOUND+OZONE+WATER VAPOR [symbol] PARTICULATES (5)

In the above reaction a halogenic compound is reacted with ozone for forming atmospherically unstable products in the form of products having additional oxygen added thereto. A convenient source of halogenic compounds include, but not limited to, solid iodine, bromine liquid, brominated oils and various other volatile brominated organic compounds. Appropriate iodine sources are easy to create since elemental iodine has a comparatively high vapor pressure and a significant quantity of it will vaporize at room temperature. For example, one of the many convenient sources of iodine may be a porous substrate impregnated with elemental iodine.

### BRIEF DESCRIPTION OF THE DRAWINGS

FIG. 1A shows a schematic of a method and apparatus for ventilating a relatively enclosed environment by use of a harmful airborne agent encapsulation device.

FIG. 1B shows a schematic of a schematic of a method and apparatus for ventilating an enclosed environment by the encapsulation of harmful airborne agents by agglomerated particulation.

FIG. 1C shows a schematic of a method and apparatus for ventilating an enclosed environment by the incineration of harmful airborne agents.

FIG. 1D shows a schematic of a method and apparatus for ventilating an enclosed environment by the encapsulation of harmful airborne agents for improving the efficiency of a variety of particle removal instrumentalities.

FIG. 1E shows a method and apparatus for ventilating and enclosed space by the use of a particulate enhanced stratification device

FIG. 1F shows a method and apparatus for the conditioning of air using non-activated encapsulation.

FIG. 2 shows a schematic of a method and apparatus for ventilating the passenger compartment of a transport vehicle.

FIG. 3 shows a ventilative device in the form of a mask

FIG. 4 shows a schematic of a method and apparatus for the ventilation of a harmful airborne agents generator.

FIG. 5 shows a another schematic of a method and apparatus for the ventilation of a harmful airborne agent generator.

FIG. 6 shows a schematic of a method and apparatus for the conditioning of air over a city.

FIG. 7 shows a schematic of a method and apparatus for the conditioning of air by use of a window installed unit.

FIG. 8 shows a method and apparatus for the detection of harmful airborne agents using particulation processes.

### DETAILED DESCRIPTION OF THE INVENTION

The present invention is capable of numerous specific embodiments and applications for the conditioning of air or synthetic atmospheres for human use. The accompanying drawings are primarily intended for explanatory purposes in order to aid or facilitate an understanding of certain presently preferred embodiments or forms of devices of the present invention. Among these preferred embodiments for the conditioning of air is a ventilative device employing an induced or forced air flow for the ventilation, heating, humidification or air conditioning of relatively enclosed spaces of a type frequented by humans, such as but not limited to, homes, apartments, farm buildings, commercial and industrial buildings, workshops, garages, greenhouses, factories, warehouses, aircraft and land crafts for transporting one or more people such as automobiles, trucks and trailers and water craft such as boats and ships. The ventilative device is particularly useful for the ventilation of enclosed spaces, such as but not limited to, hospitals, dental offices, doctors' offices and other health care facilities that are subjected to high levels of bio-aerosols in the form of airborne bacteria, fungi, viruses and other suspended pathogenic organisms. The ventilative device is also particularly useful where there is a need for a flow of conditioned air having very low particle counts therein for (1) inhibiting the spread and/or transmission of disease or infection (2) for reducing the incidence of aerosol stimulated asthma or allergic reactions from bio-aerosols in the form of airborne pollen, animal dander or other nasal irritants or (3) for protecting exposed surfaces, such as but not limited to, the eyes, nose, lungs or wounds of an individual from irritating or infectious harmful airborne agents and the surfaces of inanimate objects such as, but not limited to, semiconductor devices, food and food handling equipment, drug and drug handling equipment and other such surfaces that are exposed to harmful airborne agents during the manufacture or use.

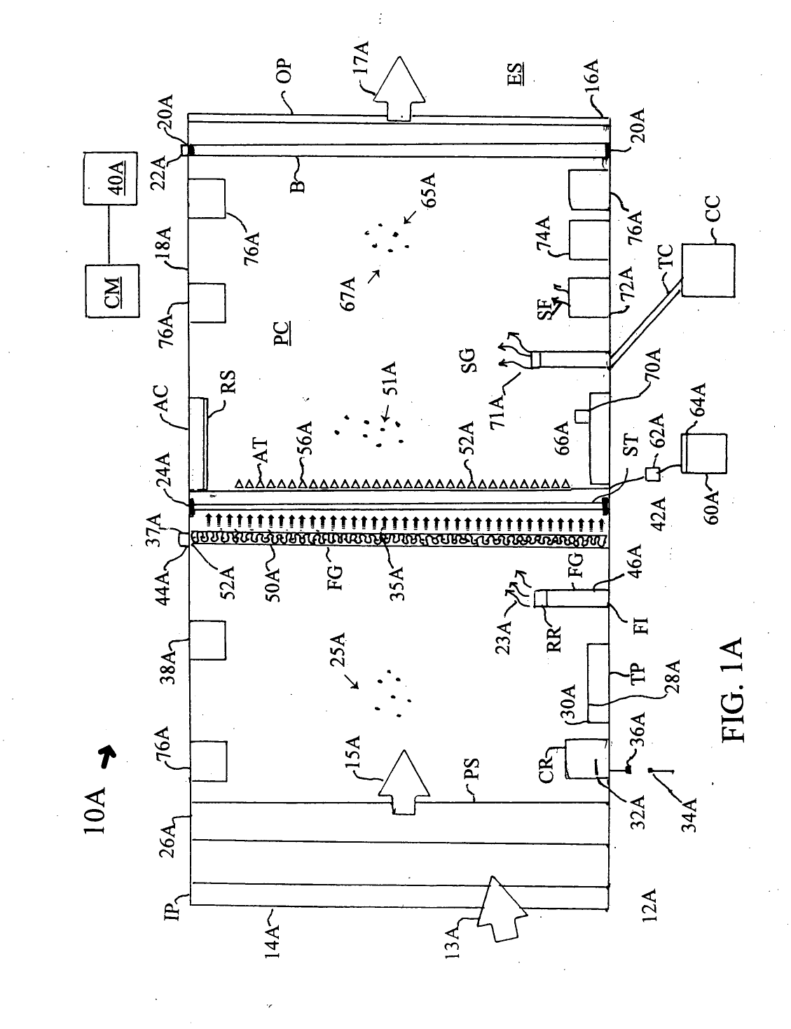

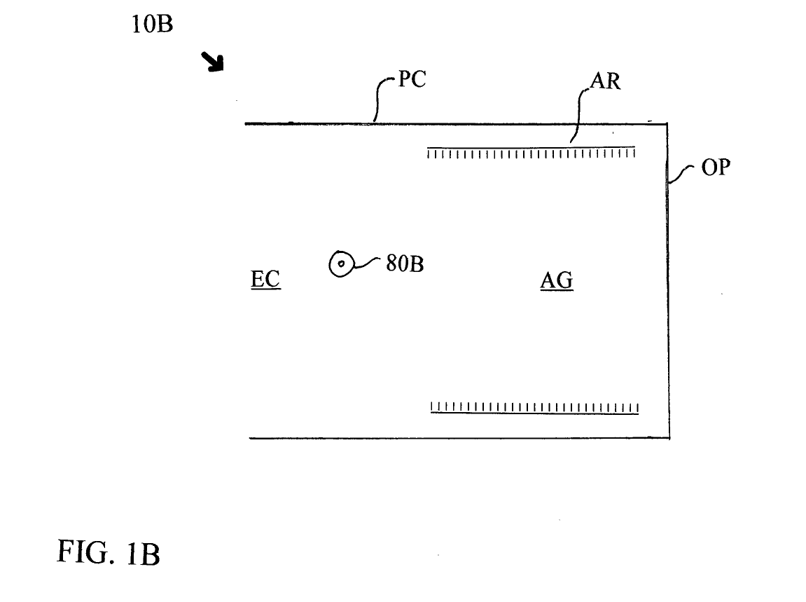

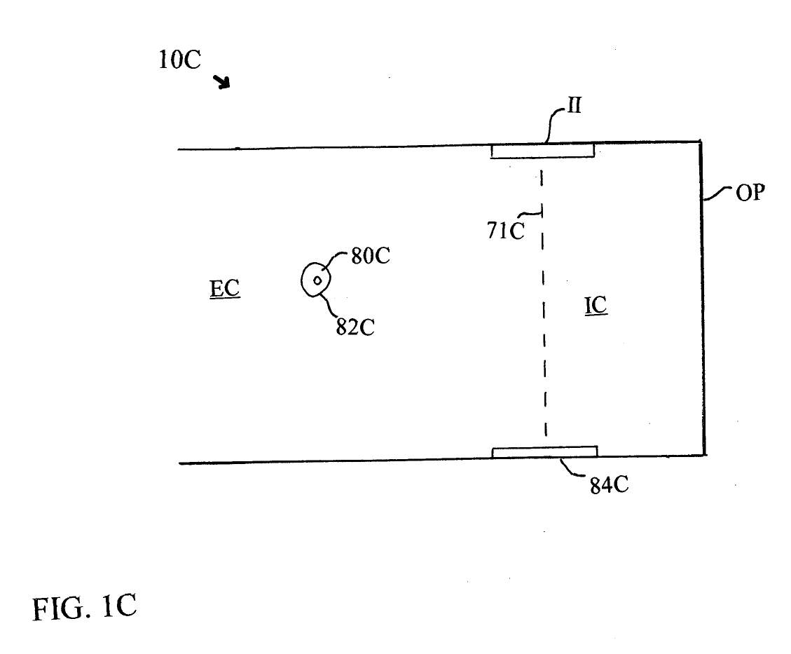

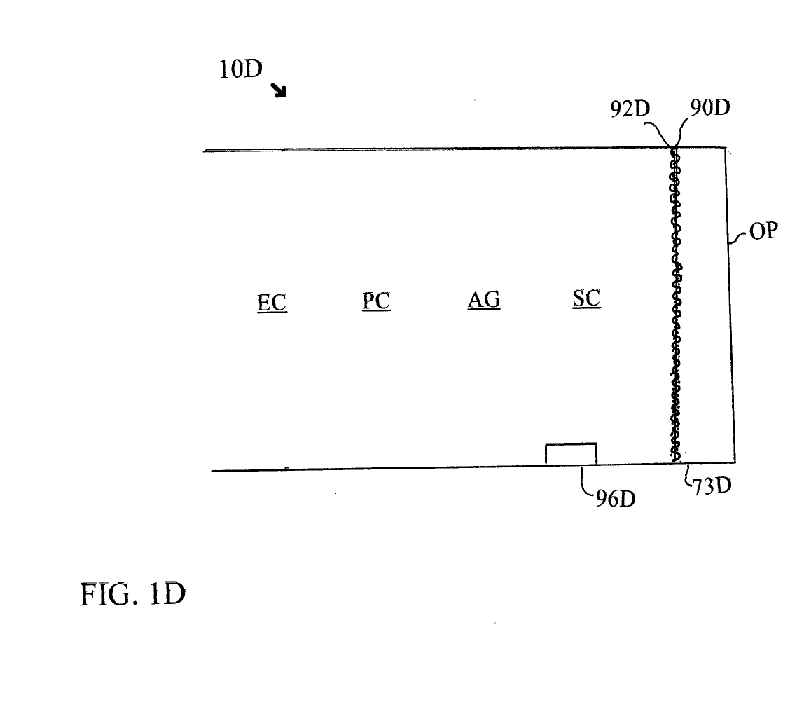

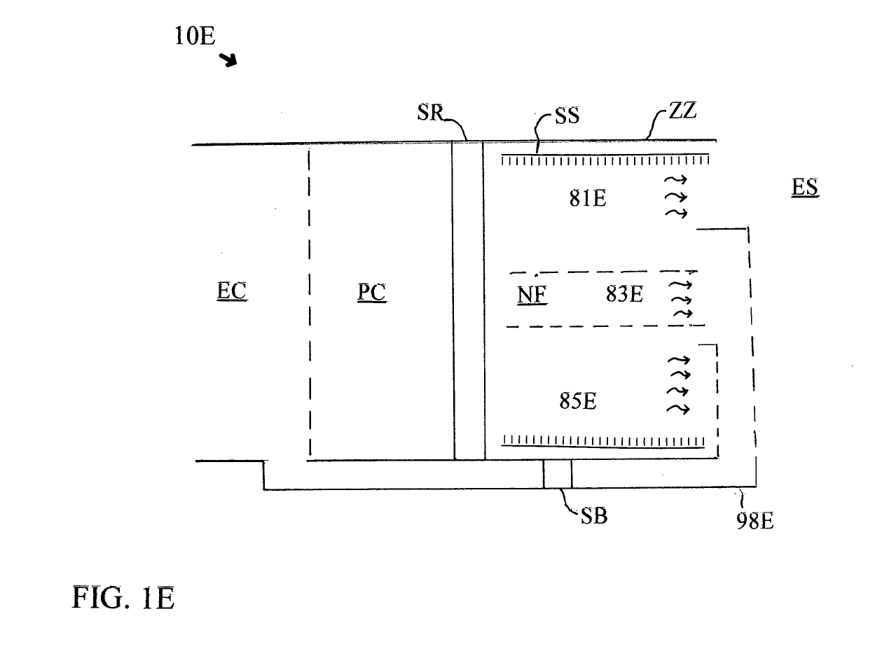

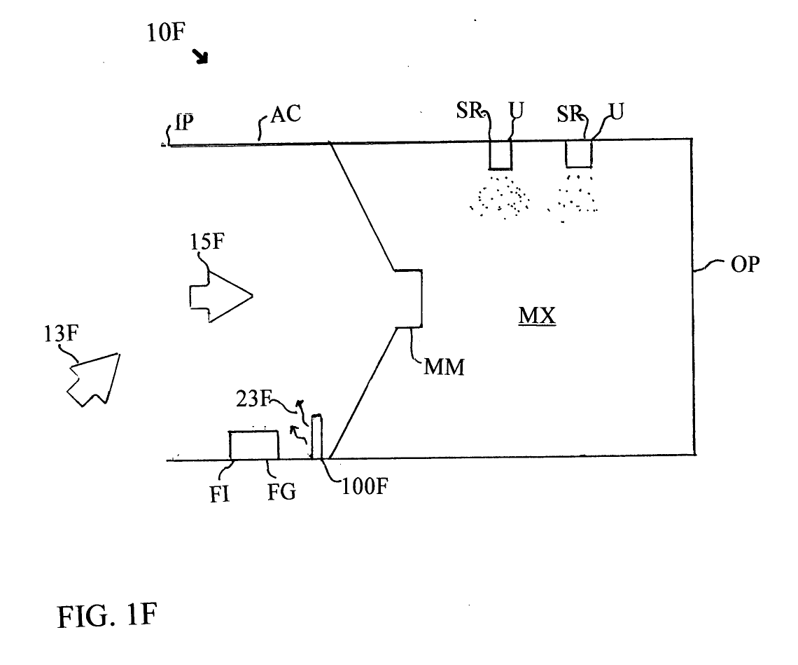

Now referring to an exemplary disclosure of the present invention for the conditioning of air as illustrated in the FIG. 1A, wherein there is shown a schematic of a method and apparatus for ventilating an enclosed environment by the encapsulation of harmful airborne agents. The apparatus is an encapsulation device generally indicated by the numeral 10A. The invention contemplates a suitable encapsulation device 10A, in a practical and commercial form for practicing the process of air purification by particulate formation, but the encapsulation device 10A as with the other devices incorporated herein may be of any suitable or desired form, without departing from the spirit or scope of the invention, inasmuch as the invention is not limited to the exact construction shown and described but is rather limited only by the claims.

Encapsulation device 10A may comprise a single elongate casing or may be of a multiple chambered type structure as illustrated and hereinafter referred to as housing 12A. Housing 12A can be substantially square or rectangular in shape and appropriately sized for retrofitting into an existing ventilation system such a central air-conditioning unit, a mechanical forced air type ventilation system, a window, or other air handling device such as those used to condition transportation vehicles. In one form of the invention, housing 12A may be retrofitted into the ventilation system for conditioning of the air throughout a building. For multi-chambered buildings having a room wherein airborne pollutants are generated, such as but not limited to, copier rooms, computer rooms, bathrooms, operating rooms, and other compartmentalized enclosures wherein bio-aerosols or hydrocarbons are generated, housing 12A may be individually retrofitted to the intake duct or vent thereof for preventing the spread of harmful airborne agents throughout the ventilation system. For buildings having one or more zones or rooms having a legislatively mandated level of high air purity above that required for office buildings, such as but not limited to, operating rooms, isolation wards, patient burn rooms, nurseries, and the like, housing 12A may be retrofitted to the outlet duct or vent thereof for providing for a sufficient degree of air purity for that particular room.

When retrofitted to an existing air-conditioning unit, housing 12A may be directly connected to the environmental controls and flow instrumentalities of the preexisting system for operating the encapsulation device 10A in accordance with the teachings of the present invention or housing 12A may be provided with an air flow sensor for indirectly connecting to the flow instrumentalities of the preexisting system.

In another form of the invention, housing 12A contains all of the operative parts therein for the conditioning of breathable air in accordance with the teachings of the present invention. For the sake of clarity and completeness, encapsulation device 10A is illustrated as a complete air handling unit.

Housing 12A has an inlet portion or conduit IP for both receiving the aeriform contents of a volume of air generally indicated by the numeral 13A and for allowing for the passage of air 13A in the form of a confined flow generally indicated by the arrow 15A to pass through an activation chamber AC then through a particulation chamber PC and out an outlet portion, conduit or register OP for forming a stream of conditioned ventilation air generally indicated by the arrow 17A. Inlet portion or conduit IP may, for example, form or comprise a main return duct or main distribution supply duct of a central air-conditioning system.

Inlet IP can be provided with a mechanically removable or clip type vent covering 14A. Vent covering 14A can be in the form of a protective wire mesh or screen for protecting housing 12A and the components therein from wind blown or otherwise projected dust, dirt and the like or vent covering 14A can be in the form of a stylishly louvered panel for concealing the mouth portion of inlet IP from view. A stylish ventilation panel 16A, which may be operatively louvered can be provided over outlet OP for both concealing the mouth portion thereof and/or for controlling the direction of flow 17A.

A source of motive power such as but not limited to a blower or flower BL is provided for forming streams of air 15A and 17A. Blower BL is operatively sized for ventilating an enclosed air space that is in fluid communication with outlet OP with a gentle circulation of air. For enclosed spaces such as buildings blower BL can be in the form of a high volume electric driven squirrel cage blower. Blower BL can be, for example, operatively located in fluid communication with inlet IP for forcing or inducing an air flow therethrough. As a non-limiting example, fan BL may be functionally located within a duct portion 18A of housing 12A that is situated between particulation chamber PC and outlet OP as illustrated. A sound absorbing lining 20A may be operatively disposed within duct portion 18A for preventing noise transfer from fan BL.

A mechanically or electronically controlled shutter or stopper ST may be provided in fluid communication and preferably within or functionally attached to housing 12A for stopping the flow of contaminated air through encapsulation device 10A when not in operation. As a non-limiting example, shutter ST may be conveniently positioned in fluid communication with inlet portion IP as illustrated. Shutter ST may be sealingly disposed within housing 12A by the use of an appropriate gasket 24A for allowing for an air tight fit when shutter ST is closed.

Blower BL can be energized by the actuation of a speed variable switch 22A for controlling the total amount of air blown through housing 12A in an intermittent or continuous manner. Blower BL is operatively sized for ventilating an enclosed space ES with a gentle circulation of air. Switch 22A and shutter ST can be communicatively connected to a control module or logic device CM through a plurality of electrical cables 19A and 21A respectfully for receiving command signals therefrom. Control module CM can be in the form of a programmable microprocessor, or in the form of mechanical and/or electronic logic arrangements of any suitable kind.

Depending upon the type of particle laden air to be treated, a pre-separator PS may be provided for separating the more course or heavy particles from the air before treatment. Pre-separator PS can be a filter, another art type separator or a separator of a type in accordance with the teachings of the present invention and as described in Xx. Filter PS may be replaceably mounted onto a flange or bracket affixed within a conduit 26A and located just behind inlet cover 14A by the appropriate use of hardware or clips.

After air 13A has been introduced into housing 12A, a fluid flux generator FG releases a flux of fluid particulate precursor material generally indicated by the arrows 23A for uniting, commingling or otherwise combining with the flow of ambient air for forming a gaseous mixture generally indicated by the numeral 25A therewith. Flux generator FG can be either located outside of housing 12A and in fluid communication therewith for providing flux 23A in a commingled state with air 13A or flux generator FG may be operatively disposed in a duct portion 26A, as shown, for releasing flux 23A into flow 15A.

In one form of the invention, flux generator FG is in the form of a fluid injector FI for introducing flux 23A in the form of a spray of liquid or gas. For example, spray injector FI may be of a type that is operated by the use of compressed gas. In this form of the invention, spray injector FI may comprise: (1) a cylinder for holding the gaseous precursor material; (2) an aerosol can; or (3) a continuously pressurized container CR for pressurizing a liquid particulate precursor material therein. Spray injector FI may have a regulator RR, which may in the form of a solenoid valve operatively connected thereto for regulating the fluid flow therefrom.

Another appropriate spray devise useful in accordance with the teachings of the present invention is an acoustic spray device of the type well known in art for generating a spray by the use of acoustic waves. The acoustic spray injector FI may be equipped with regulator RR in the form of an on/off switch.

In yet another non-limiting example, spray injector FI may be in the form of a spray device commonly used in the art of printing. In particular, spray device FI can be in the form of an ink jet printer or thermal jet printer spray device. In this form of the invention, the particulate precursor material can be comprised of a liquid having (1) a viscosity of below 20 centipoise at 25 C; (2) contain no large solid particles; (3) and be sufficiently stable so as not to dry and clog the jet orifice when not in use. Spray device FI can be fluidly connected to a replaceable or refillable source or container CR through a tube or pipe TP. Tube TP may have a fitting 28A at the end thereof for either attaching or detaching from a conjugent or counterpart fitting 30A located on container CR. In those cases wherein the reactant is a liquid, container CR may be conveniently made of a semi-transparent or transparent material such as plastic or glass for directly observing the level of fluid therein. Container CR may be accessibly located within duct portion 26A just behind filter PS for either the ease of refilling or replacement thereof.

Container CR may be provided with an art type level detector 32A for detecting the level of fluid therein. Detector 32A can be communicatively connected to module CM through an electrical cable 29A for sending level indication signals thereto. In those cases wherein container CR is a source of liquid, detector 32A may be located within container CR. In this form of the invention, electrical cable 31A may have a male connection 34A at the end thereof for plugging into a female connection 36A located on the outside of container CR for allowing for ease of the detachment thereof.

Regulator RR may be commutatively connected to control module CM through an electrical cable 27A for receiving operative command signals therefrom. In the preferred form of the invention, control module CM is programed for automatically and controllably releasing flux 23A into flow 15A for forming mixture 25A in the form of a nonflammable, nonexplosive or otherwise non-ignitable gaseous mixture.

A spray profile device 38A may be functionally placed within acoustic range of the spray generated by spray device FI for profiling both the amount and type of spray material generated. For example, profile device 38A can be positioned on an inner surface of duct portion 26A as shown. Spray profile device 38A can be of a type described in Xx. Spray profile device 38A can be communicatively connected to control module CM through an electrical cable 33A for sending spray profile signals thereto.

Module CM may be communicatively connected to a display device 40A through a cable 35A for displaying the level of the fluid in container CR.

In another form of the invention, flux generator FG is in the form of an evaporative flux generator 42A for forming flux 23A in the form of an evaporative or sublimative flux generally indicated by the arrows 35A. Evaporative flux generator 42A can be, but in no way limiting the present invention to any particular evaporative generator, in the form of a porous absorbent material. Porous material 42A can be fitted to housing 12A and as such may be in the form of a square or rectangular pad as shown. Pad 42A can be accessibly and functionally located within duct portion 26A and adjacent to or attached to filter PS for allowing easy access thereto or may be located downstream thereof in a frame holder 44A for holding pad 42A in a substantially planar form as shown. Holder 44A can be sealingly disposed in duct 26A by an appropriate gasket 37A for providing an air tight fit around the edges thereof.

Pad 42A can either be impregnated with a liquid reactant for forming a pre-soaked pad and then replaceably disposed in duct 26A or pad 42A can be fluidly connected to a container of reactant (not shown) for impregnating pad 42A in a continuous wick like manner through a wick (not shown), or an aerosol spray device 46A may be operatively located in duct portion 26A for spraying a liquid particulate precursor material onto pad 42A as shown in a continuous or intermittent fashion as needed.

A heater 50A, which can be a Joule type heater, may be incorporated into pad 42A or otherwise thermally contacted therewith for releasing evaporative flux 35A in an electrically controlled manner. Heater 50A may have a current regulator switch 52A that is communicatively connected to module CM through a cable 39A for receiving command signals therefrom.

An activator AT may be operatively positioned for delivering into chamber AC an activating flux in the form of a high intensity electrical field for activating an incipient particulation reaction therein. Activator AT can be, but in no way limiting the present invention to any particular source of high intensity electrical fields, a dc or ac corona, arc discharge, silent discharge, or streamer corona.

In one form of the invention, activator AT is in the form of a conductive plate 52A having a plurality of perforations 54A therein. On one side of plate 52A and surrounding each of perforations 54A are positioned a plurality of sharp projections 56A which act as corona electrodes. Perforated plate 52A may be operatively positioned transversely across the inlet portion of chamber AC with the projections directed therein. Plate 52A may be mechanically attached to an insulating member 58A for insulating plate 52A from housing 12A.

Conductive plate 52A can be operatively connected to an ac or dc high voltage source 60A through a cable 51A having a current limiting resistor 62A therein. A voltage regulator 64A may be operatively connected to high voltage source 60A for regulating the applied voltage to plate 52A. Regulator 64A may be communicatively connected to control module CM through a cable 41A for receiving operative command signals therefrom.

An additional activator RS, which may be in the form of a radiation source, may be optically arranged in relation to chamber AC for forming an additional flux in the form of a radiation field therein. Radiation source RS can be, but in no way limiting the present invention to any particular source of radiation, a source of microwave, RF, IR, visible or UV radiation. The interior surfaces of chamber AC may be covered with a light reflecting material 66A of such character that radiation from the source RS is reflected back and forth therein in a criss-cross pattern.

In one form of the invention, activator RS is selected and/or tuned to one or more of the resonant frequencies of one or more of the constituents of mixture 25A for activating an incipient particulation reaction. In those cases wherein the production of ozone is desired radiation source RS can be in the form of a commercially available UV lamp. UV lamp 86A can use one or more standard tubes made by for example General Electric (G25 T8 and G38 T6), Sylvania or others. The number of tubes used to bring about the particulation process may be considerably less than that needed for use in conventional UV sterilization devices. A ballast 70A may be used to convert a standard power input (e.g., 117V, 1 A60 Hz AC household current) to a form appropriate to the particular tube. For an activator RS in the form of a UV irradiator, the interior surfaces of chamber AC may be covered with reflecting material 66A in the form of polished aluminum.

In another form of the invention, activator RS is in the form of a co-activator. In this form of the invention, activator RS is selected and/or tuned to one or more of the resonant frequencies of the species generated by activator AT. In this form of the invention, co-activator RS can be, but is in no way limited to, a radiation source selected for and/or tuned to breaking an inter-oxygen bond such as found in peroxides, ozonides, ozone and the like.

Radiation source RS can be communicatively connected to control module CM through an electrical cables 43A for receiving operative command signals therefrom.

Upon activation of mixture 25A by either activator AT and/or RS a plurality of atmospherically unstable products generally indicated by the numeral 51A are formed within chamber AC. In one form of the invention, the concentration of unstable products produced within the flow of air in chamber AC are held below a level at which particulation occurs therein but rather stay in a substantially vaporous state and in a state of continuing nucleation as the flow passes out of activation chamber AC for maintaining the components therein free of particulate matter. In this form of the invention, the degree of particulation occurring within activation chamber AC may be regulated by: providing a level of flux 23A for forming mixture 25A with a particulate precursor concentration of between 1 to 10,000 parts per million or thereabouts for forming a very dilute concentration of products 51A and/or (2) the flow rate of mixture 25A is held at rate sufficient for products 51A to stay in a suspended state while traversing chamber AC. The flow rate of mixture 25A through chamber AC may be increased by simply constricting the inner diameter of chamber AC relative to the duct portions attached thereto. In the preferred form of the invention for regulating the degree of particulation in chamber AC, a particulate sensor 70A may be operatively located with respect to chamber AC for sensing the level of particulate formation therein for providing for feedback information through control module CM to flux generator FG and/or blower BL for maintaining the degree of particulation in chamber AC within a substantially particulate free state. Sensor 70A can be an art type optical particulate sensor that uses a photoelectric detector. Sensor 70A can be communicatively attached to module CM through a cable 53A for sending sensor signals thereto.

It is preferred that the temperature in activation chamber AC be maintained around or between 0 to 1000 degrees C. While this is not necessary, it is yet a convenience, and this temperature may be secured in any desired way, as by heating or cooling flow 15A or the heating effect may be produced by simply raising or lowering the air to be processed. When encapsulation device 10A is incorporated into a central air conditioning system it preferred to heat or cool the air after passing through activation chamber AC in duct portion 18A by a heater 72A and/or cooler 74A for re-circulation into inlet IP.

A humidifier 76A may also be located in duct portion 18A for humidifying the air as needed for the particulation process.

Under high particle load situations as found in, for example, health care facilities, a particle detector 76A may be operatively disposed in duct portion 26A for detecting either the level or kind of particles present in air 13A. Particle detector 76A can be an art type of particle detector or can be of a type in accordance with the teachings of the present invention and as shown in xxx. Particle detector 76A may be commutatively connected to module CM through an electrical cable 61A for sending particle detection signals thereto.

The unstable gaseous products 51A are then passed into particulation chamber PC by the moving flow of air where they continue to grow by either self nucleation and or condensation onto existing nuclei present in the ambient air for forming a particulate cloud generally indicated by the numeral 65A. In one form of the invention, precursor material 23A may be selected from the terpene compounds for forming unstable products 51A in the form of nucleogenic particles for forming cloud 65A in the form of a dispersion in air of essentially non-settling particulates. In particular, particulate precursor material 23A can be chosen for forming particulates 65A having a diameter of between 0.001 and 10 microns for forming aerosol particles capable of sustaining themselves up in the air and be carried away by the same. In this form of the invention, harmful suspended organic matter contained in the ambient air are caught up in the nucleation process by either direct condensation or by collisions with the precipitating products 51A for forming a plurality of coated or encapsulated harmful airborne agents generally indicated by the numeral 67A.

In order to increase the time spent by the harmful airborne agents in the nucleating atmosphere of particulation chamber PC, the chamber can be of greater width than the duct work connected thereto as shown for slowing the speed of the air therethrough. Particulation chamber PC is provided with a sufficiently long flow path for effecting particulation of unstable gaseous products 51A to a level sufficient for lowering the contact potential of the harmful airborne agents contained therein before dispersing the flow through outlet OP. In the preferred form of the invention, particulation chamber PC is sufficiently long for allowing for unstable products 51A to reside therein for at least one second and preferably longer.

A second fluid flux generator SFG, may be operatively positioned within particulation chamber PC for delivering a flux of co-active agents 71A into the flow therein for heterogeneously nucleating with the atmospherically unstable products. Fluid flux generator SFG, can also be in the form of a fluid injector. Fluid injector SFG may be fluidly connected to a container CC through a tube or pipe TC. Fluid injector SFG may have a regulator SRR operatively attached thereto for regulating the flux of co-active agents therefrom.

Regulator SRR may be communicatively connected to control module CM for receiving command signals therefrom.

One or more additional particulate sensors 76A may be positioned in duct 18A as shown for providing encapsulation rate or thickness levels to module CM through a plurality of cables 73A and 75A. Particulate sensors 76A can be of an art type or of a type in accordance with the teachings of the present invention and as shown in. Particulate sensors 76A may be communicatively connected to control module CM for sending particulation rate data thereto.

After the harmful airborne agents have been encapsulated they can then be either removed from the air or released into the environment. In the preferred form of the invention, fluxes 23A and flux 71A are chosen for encapsulating the harmful airborne agents in the form of an essentially non-volatile biocidal, self decomposing agent for both lowering the contact potential of the encapsulated harmful airborne agents and for coating the inside surfaces of the post activation chamber AC ventilation system, such as heater 72A and/or cooler 74A and their associated components, such as, heat exchange coils, water pans, moisten pads, and duct work with a prophylactic biocidal agent.

Before leaving encapsulation device 10A the air and or particulates may be ionized with a unitary charge by an air type charging device 78A for their subsequent manipulation by the methods and apparatuses described in my U.S. Pat. Entitled Method for Protecting Exposed Surfaces.

Now referring to FIG. 1B there is shown a schematic of a method and apparatus for ventilating an enclosed environment by the encapsulation of harmful airborne agents by agglomerated particulation. The apparatus is an particulation enhanced agglomerator generally indicated by the numeral 10B.

The agglomerator 10B is comprised of an encapsulation chamber EC wherein harmful airborne agents are encapsulated in an outer layer 80B. In the preferred form of the invention, the particulate precursor material is chosen for forming an outer layer 80B upon the harmful airborne agents that is comprised of a sticky substance for increasing the probability of adhesion thereof.

Agglomerator 10B further comprises an agglomeration chamber AG having an agglomerator AR located therein. Agglomeration chamber AG may be incorporated into a particulation chamber PC or be located downstream thereof and upstream of an outlet OP as shown.

Agglomerator AR can be of a type well known in the art, such as but not limited to, an acoustic or electrostatic agglomerator. For example, agglomerator AR can be of an acoustic type described in ES-459 523 A1 or of a described U.S. Pat. No. 5,827,350 and related work thereto as found at the USPTO web site illustrating this patent or agglomerator AR can be in the form of an electrostatic agglomerator AR has shown

In another form of the invention, the particulate precursor material and/or co-active agents are selected for encapsulating the harmful airborne agents with an incinerary layer.

An agglomerator AG may be placed down stream of particulation chamber PC for agglomerating the thickly coated harmful airborne agents.

Now referring to FIG. 1C there is shown a schematic of a method and apparatus for ventilating an enclosed environment by the incineration of harmful airborne agents. The apparatus is a particulate enhanced incineration device generally indicated by the numeral 10C.

The incineration device 10C is comprised of an encapsulation chamber EC for forming conditioned harmful airborne agents in the form of encapsulated particles having an outer layer 80C comprised of an incinerary substance 82C. In one form of the invention, incinerary substance 82C may be comprised of a radiation excitable material for allowing for the incineration of the harmful airborne agents at low temperature upon irradiation thereof by, for example, and in no way limiting the present invention to any particular form of radiation, microwaves, RF, IR, visible or UV radiation. The radiation excitable material may be comprised of one or more of the following: (1) an oxidizing agent for oxidizing the harmful airborne agents upon irradiation thereof; (2) a kindling type agent for igniting the harmful airborne agents by heat transfer processes upon irradiation thereof; or (3) a resonator like agent for activating the incineration of the harmful airborne agents upon irradiation thereof.

The excitable oxidizing agent can be, for example, of a type having a dissociative absorption spectrum in the UV range for forming oxidizing radicals upon irradiation by UV light. Suitable examples of such excitable oxidizing which may be used in accordance with the teachings of the present invention include, but not limited to, peroxide compounds and/or compounds that form peroxides when excited in air such as unsaturated hydrocarbons.

The excitable kindling agent can be in the form of a substance having a lower ignition temperature then the harmful airborne agents. Suitable examples of such excitable agents include, but are not limited to, ozonide compounds and compounds that form ozonides upon irradiation thereof.

A suitable example of an excitable resonator like material can be, for example, water for resonating energy upon irradiation thereof by for example microwave radiation.

Incineration device 10C further comprises an incineration chamber IC having an incinerator II located down stream of encapsulation chamber EC and upstream of an outlet OP. In one form of the invention, incinerator II is in the form of one or more radiation devices. In the preferred form of the invention, radiation device II is optically positioned within chamber IC for illuminating at least one entire cross sectional area generally indicated by the line segment 71C lying across chamber IC for impinging radiation upon all of harmful airborne agents passing therethrough. Radiation source II can be in the from of a microwave, ir heater, lamp, arc lamp or flashlamp or laser.

Radiation source II can be selected and/or tuned for exciting one or more of the atmospherically unstable products. In those cases wherein the atmospherically unstable products are in the form of either hydrogen peroxide or organic peroxides radiation source II may be selected and/or tuned for dissociating the peroxide bond for forming hydroxide radicals.

Incineration chamber IC may be coated with a reflective material 84C for increasing the intensity of illumination upon the encapsulated harmful airborne agents.

Now referring to FIG. 1D there is shown a schematic of a method and apparatus for ventilating an enclosed environment by the encapsulation of harmful airborne agents for improving the efficiency of a variety of particle removal instrumentalities. The apparatus is a particulate enhanced removal device generally indicated by the numeral 10D.

The enhanced removal device 10D is comprised of an encapsulation chamber EC for the encapsulation of harmful airborne agents therein. Removal device 10D further comprises a separation chamber SC having a separator SR located therein for separating the encapsulated harmful airborne agents from the air. Separation chamber SC may be operatively located just downstream of a particulation chamber PC associated with encapsulation chamber EC or may be operatively located just downstream of an agglomerator AR and upstream of an outlet OP has shown.

In one form of the invention, separator SR is in the form of a capturing structure 90D for capturing the encapsulated harmful airborne agents. Capturing structure 90D can be, but is not limited to, a non-gravitationally operated capturing device such as an electrostatic precipitator which can be in the form of an electrostatically enhanced filter or can be in the form of a filter 90D has shown. Filter 90D can be mechanically disposed by the appropriate use of brackets and hardware transversely across chamber SC for intercepting and filtering the air flow therethrough. A gasket 73D may be provided for sealing filter 90D within chamber SC with an air tight fit.

In one form of the invention, filter 92D functions as both a capturing device and an incinerator. In this form of the invention, filter 90D can be provided with an outer catalytic layer 92D for increasing the incineration rate of the encapsulated harmful airborne agents when either heated by a heater 94D and/or when illuminated by a UV source 96D as also shown. Heater 96D can be an in the form of an electric heater that can be incorporated into filter 90D or be otherwise be in thermal contact therewith. In this form of the invention, it is preferred that substance outer layer having a sticky consistency for either (1) increasing the probability of adhesion onto the capturing surface and/or (2) to increase the probability of retention thereof onto the surface and have an incinerary nature.

In another form of the invention, separator SR is in the form of a stratifier SS.

Now referring to FIG. 1E there is shown a schematic of a method and apparatus for ventilating and enclosed space by the use of a particulate enhanced stratification device generally indicated by the numeral 10E.

Enhanced stratification device 10E is comprised of an encapsulation chamber EC for encapsulation harmful airborne agents therein. Enhanced stratification device 10E further comprises stratification chamber ZZ having a stratifier SS therein for stratifying the air into a plurality of flows generally indicated by the arrows 81E, 83E and 85E having different concentrations of harmful airborne agents therein. Stratification chamber ZZ may be operatively located downstream of encapsulation chamber EC or located downstream of a separator SR as shown. Stratifier SS can be in the form of either an inertial type separator, such as a cyclone, or an electrostatic stratification device as shown. Electrostatic stratifier SS may be an in the form of an electrostatic stratifier having a pair of oppositely charged corona electrodes for concentrating the encapsulated harmful airborne agents in a neutralization field NF. In this form of the invention, stratification device SS can act as both an agglomerator and as a stratifier by running the electrostatic stratification device SS in an AC mode.

The stratified layers 83E having a higher concentration of harmful airborne agents may be recycled through a conduit 98E back into encapsulation EC for subsequent enlargement and capture by a blower SBL. The airborne agents may be recycled into the mouth portion of an activation chamber AC or may passed into a particulation chamber PC as shown.

In yet another form of the invention, the particulate precursor material is particulated by non-activation processes.

Now referring to FIG. 1F there is shown a method and apparatus for the conditioning of air using non-activated encapsulation. The apparatus is a non-activated encapsulation device generally indicated by the numeral 10F.

The non-activated encapsulation device 10F is comprised of an inlet portion or conduit IP for both receiving the aeriform contents of a volume of air generally indicated by the numeral 13E and for allowing for the passage of air 13F in the form of a confined flow generally indicated by the arrow 15F to pass through an activation chamber AC in the form of a mixing chamber MX then through a particulation chamber PC and out an outlet portion, conduit or register OP for forming a stream of conditioned ventilation air generally indicated by the arrow 17F.

Mixing chamber MX may have a fluid flux generator FG located therein for providing for a flux 23F of a particulate precursor material. Flux 23F of particulate precursor material can be in the form of substance that reacts with air and/or the humidity therein under ambient conditions for forming particulates. For this purpose the particulate precursor material can be in the form of an acid vapor, such as but not limited to, hydrofluoric acid vapors.

Flux generator FG can be in the form of a fluid injector FI. Fluid injector FI may be operatively directed at a heated element 100F for impinging particulate precursor material thereon for forming flux 23 therefrom.

Mixing chamber MX further comprises a mixer MM for mixing flux 23F with flow 15F for activating a particulating reaction thereby.

A separator SR in the form of a scrubber U, of a conventional type, may be provided tor for removing the encapsulated harmful airborne agents by scrubbing techniques.

A conventional condensation type enlargement device of a type well known in the art may be used prior to separation by separator SR for enlarging the particulated harmful airborne agents for ease of removal.

From a consideration of the structures described in the preceding FIGS. 1A-1F it will be realized by those skilled in the field of air purification that virtually an indeterminate number of differently constructed structures can be built so as to utilize the principles of the present invention embodied within the structures shown. In addition, it will be realized by those skilled in the art that it is not indispensable that all the features of the invention be used conjointly, since they may be employed advantageously in various combinations and sub-combinations.

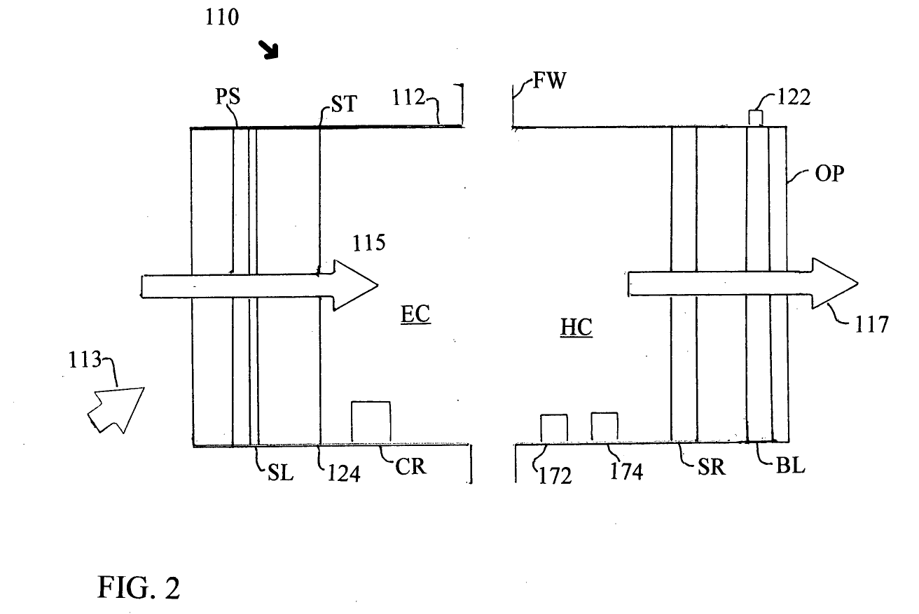

Now referring to FIG. 2 there is shown a schematic of a method and apparatus for ventilating the passenger compartment of a transport vehicle. The apparatus is an automotive air conditioner generally indicated by the numeral 110. The automotive air conditioner 110 is useful in the conditioning of air as found in highway environments. In particular, air conditioner 110 is useful in the remediation of the pollutants as found in highway contaminated air such, as but not limited to, PM10 carbon particles from engine exhaust and tire-dust, minute fibers of asbestos from brake-linings, molecular contaminants such as hydrocarbons, carbon monoxide, and the oxides of nitrogen.

The functional components that comprise automotive air conditioner 110 can be installed during vehicle assembly within a single casing located in a portion of the passenger compartment. In this form of the invention, both an outside air inlet IP and a source of particulate precursor material CR can be fluidly connected to air conditioner 110 through a plurality of fluid connections that pass through a fire wall FW for providing source material thereto.

When retrofitted to an existing vehicle the components may be accommodated in a multi-chambered housing 112 as shown. Multi-chambered housing 112 is comprised of an encapsulation chamber EC and a temperature control chamber or HVAC chamber HC that are located on opposite sides of fire wall FW. Encapsulation chamber EC is fluidly connected to outside air inlet IP for both receiving the aeriform contents of a volume of air generally indicated by the numeral 113 and for allowing for the passage of air 113 in the form of a confined flow generally indicated by the arrow 115 to pass through encapsulation chamber EC then through an HVAC chamber HC and out one or more interior outlet vents OP for forming a stream of conditioned ventilation air generally indicated by the arrow 117 for ventilating a passenger compartment.

Inlet IP may be in the form of a plurality of louvers operatively located rearwardly of the hood of a passenger vehicle PV and across the front of the windshield.

HVAC chamber HC accommodates therein a blower fan BL for forming streams of air 115 and 117. Blower BL is operatively sized for ventilating the passenger compartment with a gentle circulation of air. Blower BL can be, for example, in the form of a scirocco or centrifugal multi-blade fan. Blower BL can be energized by the actuation of a speed variable switch 122 for controlling the total amount of air blown through air conditioner 110 in an intermittent or continuous manner.

HVAC chamber HC also can accommodate a temperature control system for controlling the temperature of flow 117. The temperature control system includes a heater core 172 and an evaporator coil 174 each having portions disposed within said chamber.

A shutter ST may be provided for stopping the flow of contaminated air through air conditioner 110 when not conditioning outside air 113. Shutter ST may be sealingly disposed within housing 12 by the use of a gasket 124.

Switch 122 and shutter ST can be communicatively connected to a control module or logic device, such as a computer, CM through a plurality of electrical cables 119 and 121 respectfully for receiving command signals therefrom. Control module CM can be commutatively connected to both a manual speed variable switch and a inside-air/outside air switch located in the passenger compartment for receiving command signals therefrom.

A Pre-separator PS can be replaceably located in a receiving duct portion 126 through a slot SL for separating the more corse contaminates from air 113. Pre-separator PS can be in the form of a filter or be in the form of an automotive centrifugal separator as shown in Xx. Duct 126 can be fluidly connected to encapsulation chamber EC for providing air flow 115 thereto.

The particulated gaseous material from encapsulation chamber EC is then passed into HVAC chamber HC through a connecting duct CD for further conditioning the air if desired.

A separator SR may be operatively disposed down stream of encapsulation chamber EC such as in an outlet duct portion OP for removing the encapsulated harmful airborne agents from the air.

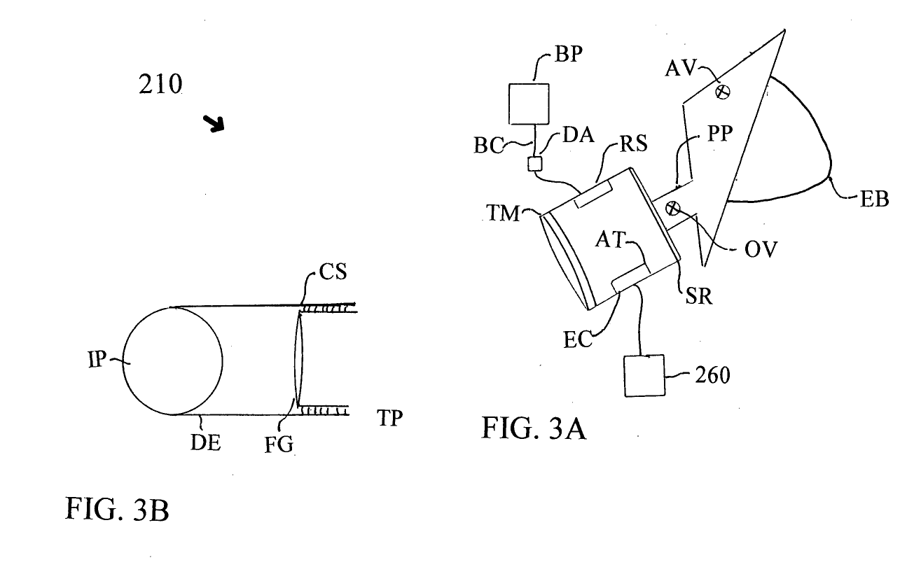

Now referring to FIGS. 3A and 3B there is shown a ventilative device in the form of a mask generally indicated by the numeral 210. Mask 210 is comprised of a non-porous face mask portion or chamber MP and an encapsulation chamber EC. One or more elastic bands EB may be operatively connected to mask portion MP for securing the same to the user thereof. Mask portion MP can be made of a flexible material for providing an air tight fit over the nose and mouth of the user when worn.

Mask 210 has an inlet portion or conduit IP for both receiving a volume of air generally indicated by the numeral 213 and for allowing for the passage of air 213A in the form of a confined flow 215 to pass first through a distal end portion DE of encapsulation chamber EC then through a central portion CP of encapsulation chamber EC then out a proximal portion PP then through a connecting duct CD and finally into mask portion MP upon inhalation.

Inlet opening or conduit IP may be provided in the form of an air permeable porous cap member. In one form of the invention, cap member can be in the form of a replaceable or single use member made of a molded harden plastic or polymer material for use in non-contact environments such as a for example, a medical environment. In another form of the invention, cap member can be comprised of stainless steal for use in contact environments such as but not limited to, a battle field environment.

As seen in FIG. 3B, cap IP can be provided with a inner circular slot or groove CS encompassing an inner portion thereof for receiving a pre-soaked pad or circular diskette FG. Cap IP is provided with an inner threaded portion TP for forming a female connector portion of a male/female connection.

Distal end DE may be provided with an outer threaded male projection TM for both securing cap IP thereon and for compressibly holding diskette FG therebetween in such a manner as to obtain an air tight fit between cap IP and distal end DE when throughly connected.

Cental portion CP of encapsulation chamber EC is provided with one or more activators or co-activators AT and RS for activating a gas-to-particle reaction therein. For example, activator AT can be in the form of a circular perforated plate corona. Corona diskette AT can be energized by a capacitive type of high voltage source 260 of a type well known in the art of electrostatic spraying, through a cable for providing an electrifying charge thereto.

In one form of the invention, co-activator RS is in the form of an ozone decomposition UV light source for decomposing the ozone produced by corona diskette AT. UV light source RS can be energized by a rechargeable battery pack BP through a cable BC having a dc/ac converter DA therein.

Proximal portion PP of encapsulation chamber EC may be provided with a particulate separator SR. Separator SR can be in the form of an ozone decomposition/capturing device, such as for example, a filter covered either with (1) an ozone decomposition catalyst or a react for reacting with the ozone.

Connecting duct CD has a one way valve OV incorporated therein for allowing the passage of air to pass therethrough.

Mask portion MP is provided with an additional one way valve AV for allowing the passage of air out thereof during expiration. Valve AV may be operatively disposed within mask portion MP as shown.

Battery pack BP and capacitive energizer 260A can be provided with a low power warning circuit that indicates when either energizing source is low. In the preferred form of the invention, the circuit provides a signal to an LCD to display a message to energize the energizing source and to replace pad FG. For this purpose pad FG is pre-soaked with a particulate precursor in amount sufficient for providing a flux 23 of particulate precursor material as long the energizing source remains energized.

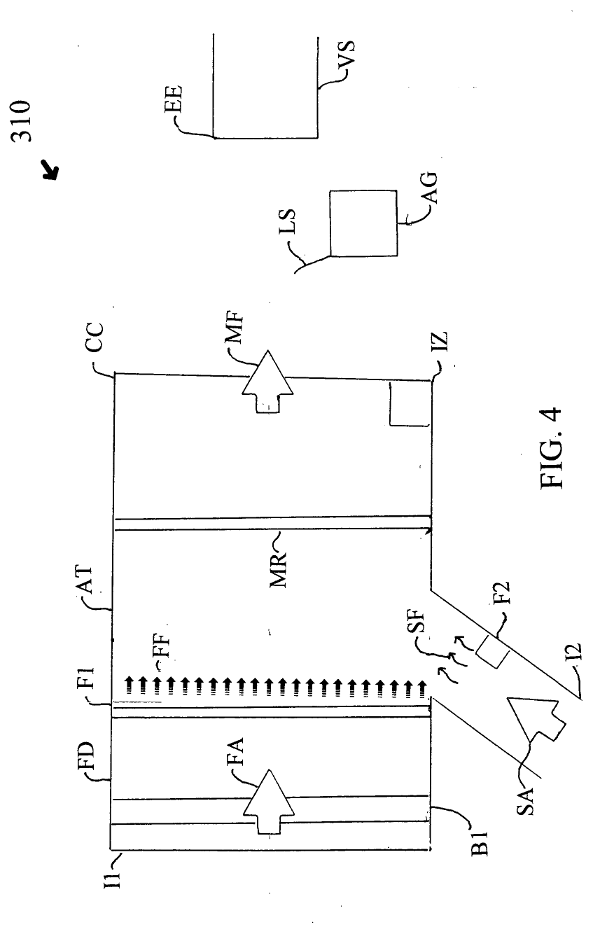

Now referring to FIG. 4 there is shown a schematic of a method and apparatus for the ventilation of a harmful airborne agents generator. The apparatus is an in situ particulation device generally indicated by the numeral 310.

The in situ particulation device 310 is comprised of an activation chamber AT in the form of a mixing chamber XC. Mixing chamber XC is fluidly connected to a first duct FD. First duct FD as a first blower BL1 therein for inducing a volume of air through an inlet IL1 for forming a flow of air generally indicated by FA. Flow FA is blown passed a first flux generator FG1 for receiving a first flux FF of particulate precursor material therein before entering mixing chamber XC. First flux generator FG1 can be in the form of a porous pad saturated with a terpene compound for forming first flux FF in the form of an organic or terpenic flow.

Mixing chamber XC is also fluidly connected to a second duct SD. Second duct SD as a second blower BL2 therein for inducing a volume of air through an inlet IL2 for forming a flow of air generally indicated by SA. Flow SA is blown passed a second flux generator FG2 for receiving a second flux SF of particulate precursor material therein before passing into mixing chamber XC. Second flux generator FG2 can be in the form of an ozonizer for forming second flux SF in the form of an oxidizing flow.

The two flows FA and SA are then mixed in mixing chamber XC by a mixer MR for activating an incipient particulation reaction by forming a mixed flow generally indicated by MF.

Mixed flow MF is then passed out of an outlet or channel CC for channeling the particulating mixture within an aerosol projection path generally indicated by the line segment LS of an aerosol generator AG for particulating a plurality of aerosol particles therein.

An ionizer IZ may be operatively located within channel CC providing flow MF with a unitary electrostatic charge.

A vacuum source VS may be provided for removing the particulated harmful airborne agents from the ambient air. Vacuum source VS may be provided with an electrostatic electrode EE for inducing the charged particulated harmful airborne agents therein.

A particulate precursor level detector may be provided and be mechanically or electronically communicatively connected to ozonizer FG2 for turning off the ozonizer when the particulate precursor material is exhausted.

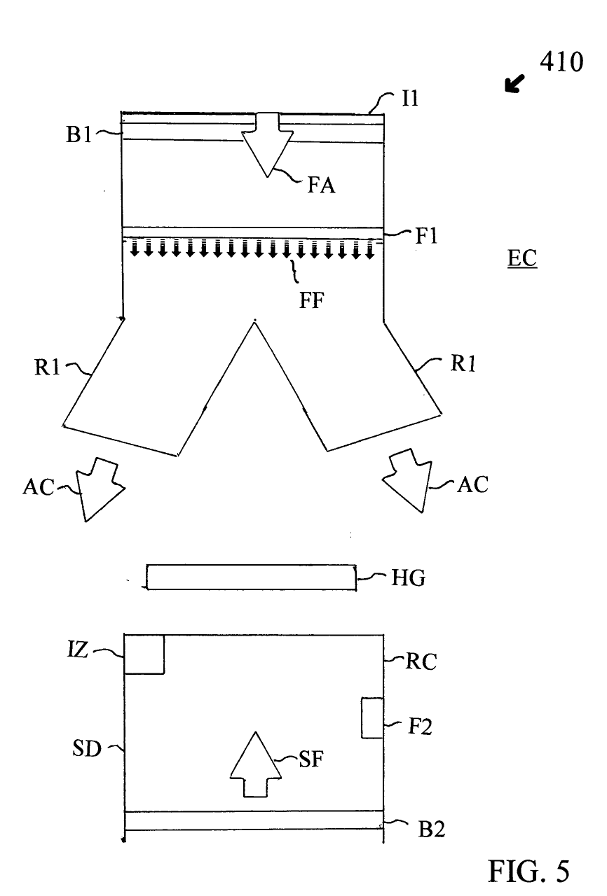

Now referring to FIG. 5 there is shown a another schematic of a method and apparatus for the ventilation of a harmful airborne agent generator. The apparatus is an in situ activation/particulation device generally indicated by the numeral 10. In situ activation/particulation device 410 is illustrated for use for the remediation of aerosoled anthrax spores generated by a post office machine.

The in situ activation/particulation device 410 is comprised of a first duct FD having a first blower BL1 therein for inducing a volume of air through an inlet IL1 for forming a flow of air generally indicated by the arrows FA. Flow FA is blown passed a first flux generator FG1 for forming a terpenic flow generally indicated by the arrows FF.

Terpenic flow FF is directed downwards through two rail type conduits RC1 for forming a descending duel flux air curtain generally indicated by the arrows AC that both encompasses a harmful airborne agent generator HG and isolates generator HG from the rest of an enclosure EC by wall of gaseous terpenic material AC.

A second duct SD has an ozonizer FG2 and a second blower BL2 therein for forming an oxidizing flow generally indicated by the arrow SF thereby. Flow SF is passed through a second rail conduit RC2 for forming an oxidizing flux OF that is directed into an environment containing harmful airborne agents generated by generator HG. In the preferred form of the invention, the oxidizing flux OF is directed upwardly towards a region of lower pressure created by a vacuum source VS.

An ionizer IZ may be provided in duct SD for charging flow SF with a unitary charge. Vacuum source VS may be provided with an attractive electrode EE for attracting the charged particulated harmful airborne agents.

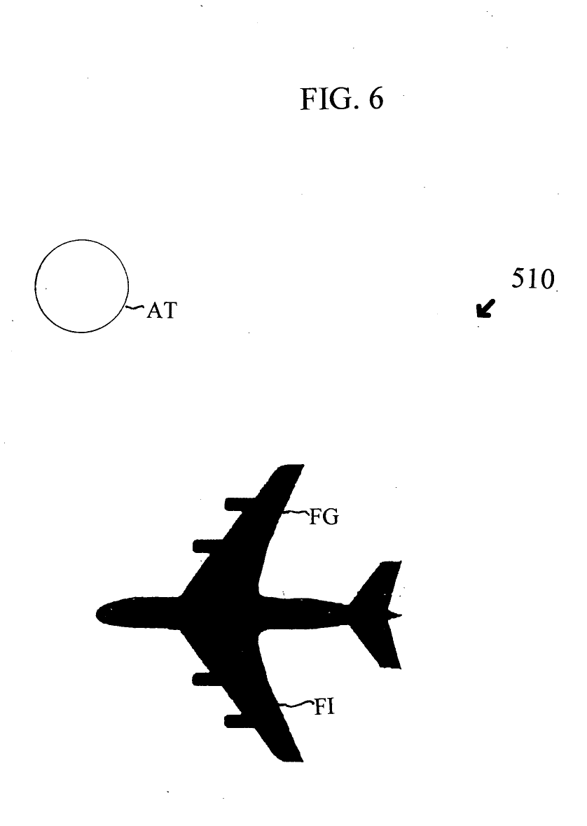

Now referring to FIG. 6 there is shown a schematic of a method and apparatus for the conditioning of air over a city. The apparatus is an outdoor air conditioning device generally indicated by the numeral 510.

The outdoor air conditioning device 510 is comprised of particulate precursor flux generator FG which can be in the form of a spray device FI. Spray device FI can be aerodynamically positioned on an aircraft for releasing a molecular disperse or gaseous solar photo-reactive particulate precursor material over and area of a city. The solar photo-reactive material can be in the form of a UV excitable organic compound which may be a terpenic or diene type compound.

The activator AT in this form of the invention is the sun. Light from the sun is used to excite the particulate precursor material for activating a gas-to-particle reaction wherein harmful airborne agents contained the air are encapsulated for lowering the contact potential thereof.

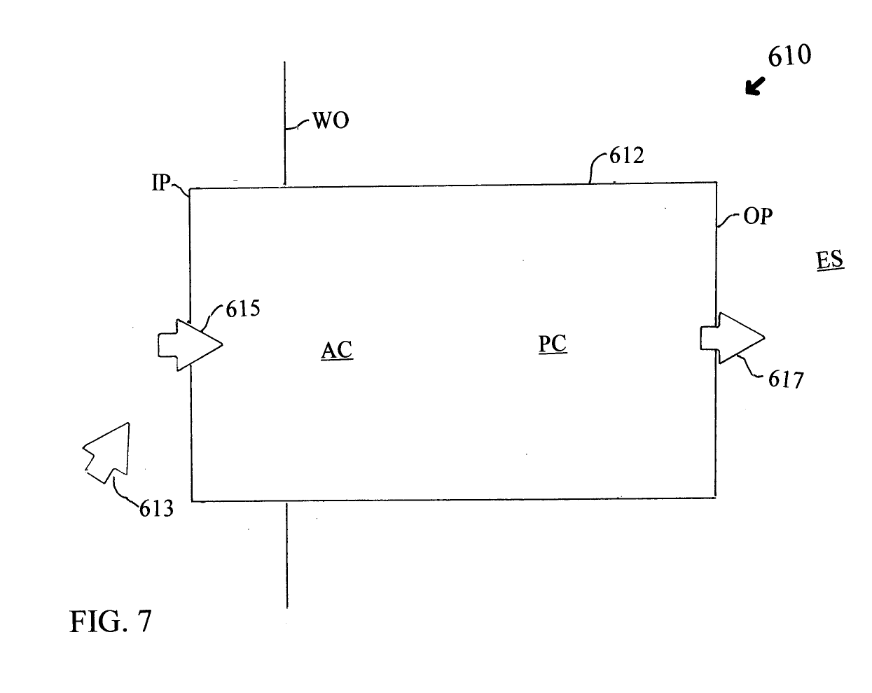

Now referring to FIG. 7 there is shown a schematic of a method and apparatus for the conditioning of air by use of a window installed unit. The apparatus is a window unit generally indicated by the numeral 610.

Window unit 610 includes a housing 612 which is designed to be mounted within an opening generally indicated by the numeral WO. Opening WO can be in the form of a window of an enclosure ES. Window unit 610 is provided with an inlet portion or conduit IP for both receiving the aeriform contents of a volume of outside air generally indicated by the numeral 613 and for allowing for the passage of air 613 in the form of a confined flow generally indicated by the arrow 615 to pass through an activation chamber AC then through a particulation chamber PC and out an outlet portion, conduit or register OP for forming a stream of conditioned ventilation air generally indicated by the arrow 617.

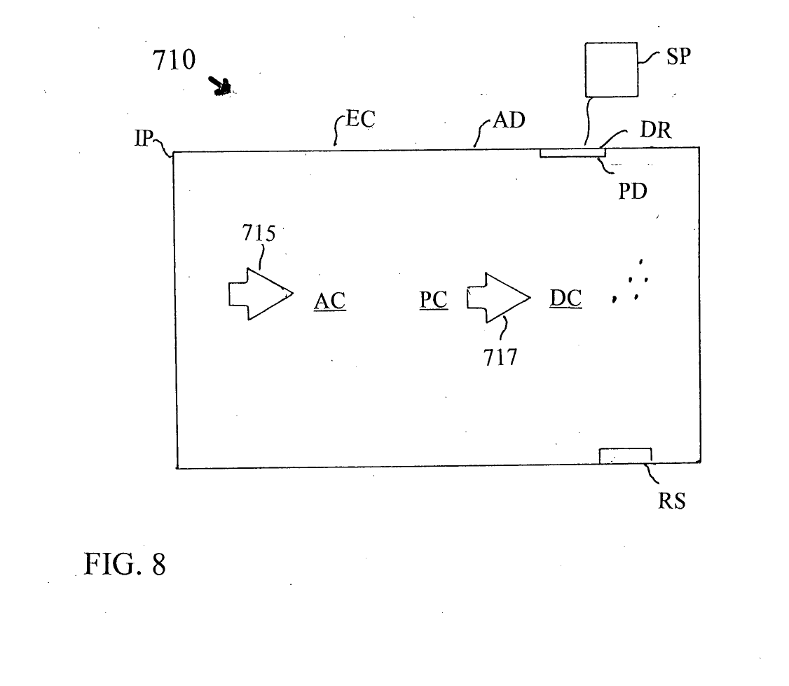

Now referring to FIG. 8 there is shown a schematic of a method and apparatus for the detection of harmful airborne agents. The apparatus is a harmful airborne agent encapsulator/detector generally indicated by the numeral 710.

The encapsulator/detector 710 is comprised of an encapsulation chamber EC and a detection chamber DC. Encapsulation chamber EC is provided with an inlet IP for both receiving the aeriform contents of a volume of gas generally indicated by the numeral 713 and for allowing for the passage of gas 713 in the form of a confined flow generally indicated by the arrow 715 to pass through an activation chamber AC then through a particulation chamber PC for forming a flow 717 of particulated agents and into a detection chamber DC.

Detection chamber DC is provided with a detector DR for detecting, identifying and characterizing the particulated harmful airborne agents. In one form of the invention, the detector is in the form of a photo-detector PD for detecting electromagnetic waves or photons brought forth by a plurality of particulated agents generally indicated by PA. The photons may be brought forth by illuminating the particulated agents with electromagnetic radiation from a radiation source RS for generating light signals therefrom. The light signals may be in the form of reflected or emitted electromagnetic radiation.

Detector DR may be connected to a signal processing device SP for processing the signals sent from detector DR.

In another form of the invention, detector is in the form of an acoustic detector AD for detecting acoustic waves brought forth by the particulate agents. The acoustic waves may be brought forth by illuminating the particulated agents with electromagnetic radiation for generating acoustic signals therefrom.

The foregoing disclosure and description of the invention are illustrative and explanatory in nature, and various changes in the size, shape, and materials may be made without departing from the spirit of the invention.

1. An apparatus for securing the comfort and health of human beings by the production and maintenance of conditioned air, said apparatus comprising;
(a) a flux generator for generating a flux of gaseous particulate precursor material;
(b) an activator functionally located within an air passageway for activating said particulate precursor material in a gas-to-particle reaction for forming atmospherically unstable products for reducing the contact potential of harmful airborne agents.

2. An apparatus as in claim 1, wherein said flux generator is of a type for forming acidic atmospherically unstable products.

3. An apparatus as in claim 1, wherein said activator is of a type for creating an intense electrical field.

4. An apparatus as is claim 1, wherein said activator is a UV light source.

5. An apparatus as in claim 1, wherein said flux generator is a generator for gaseous terpene compounds.

6. An apparatus as in claim 1, further comprising a face mask portion.

7. An apparatus for detecting harmful airborne agents, said apparatus comprising;
(a) a flux generator for generating a flux of gaseous particulate precursor material;
(b) an activator for activating said particulate precursor material in a gas-to-particle reaction for coating said harmful airborne agents for forming coated harmful airborne agents;
(c) a detector for detecting light emitted by said coated harmful airborne agents for detecting said harmful airborne agents.

8. An apparatus as in claim 7, a source of organic material for forming atmospherically unstable products in the form of organic peroxides in a gas-to-particle reaction for forming peroxide coated harmful airborne agents.

9. An apparatus as in claim 8, further comprising an excitation source for exiting said peroxide coated harmful airborne agents for emitting light therefrom.

10. A method for the purification of a fluid, said method comprising the steps of;
(a) providing a gaseous organic material;
(b) oxidizing said gaseous organic material for forming organic acids;
(c) and mixing said organic acids with said fluid for the purification of said fluid.

11. A method according to claim 10, further comprising the step oxidizing said gaseous organic material by subjecting said gaseous organic material to both ozone and UV radiation.
